(19) United States
(12) Patent Application Publication
(10) Pub. No.: US 2016/0212969 A1
(43) Pub. Date: Jul. 28, 2016

(54) Dispensing Apparatus

(71) Applicant: Sugar Tree Innovations LLC, Long Lane, MO (US)

(72) Inventor: James M. Salaki, Long Lane, MO (US)

(21) Appl. No.: 14/605,156

(22) Filed: Jan. 26, 2015

(51) Int. Cl. A01K 5/01; A01K 5/02

(52) U.S. Cl. CPC A01K 5/0114; A01K 5/0275

(57) ABSTRACT

A dispensing apparatus has a frame with a storage compartment configured for storing a substance to be dispensed and a dispensing duct configured for dispensing the dispensed substance. The dispensing apparatus has a plurality of cups. Each cup in the plurality of cups comprises a member with a hollow interior and an opening in the member that communicates with the hollow interior. Each of the cups is selectively rotatable within the frame with a drive rod. The cups may move between a dispensed substance receiving position in which the cup opening is aligned in communication with the storage compartment to receive the dispensed substance therefrom and a dispensed substance dispensing position in which the cup opening is aligned in communication with the dispensing duct to pass the dispensed substance thereto.

### BACKGROUND AND SUMMARY

The disclosure is directed to a dispensing apparatus, for instance, an animal feeder. In particular, the dispensing apparatus has multiple cups that are used to dispense a substance, for instance, animal feed, from a storage compartment to a dispensing duct. More in particular, the cups may be selectively operated in a manner to dispense a desired amount of the substance from the storage compartment to the dispensing duct.

### BRIEF DESCRIPTION OF THE DRAWINGS

FIG. 1 shows a perspective view of the dispensing apparatus with certain portions of the dispensing apparatus shown in transparency to allow illustration of internal components of the dispensing apparatus.

FIG. 2 shows a partial, perspective view of the dispensing apparatus with certain portions shown in transparency to allow illustration of internal components of the dispensing apparatus.

FIG. 3 shows a perspective view of a drive rod and cups of the dispensing apparatus with some of the cups removed for ease of illustration.

FIG. 4 is a partial, enlarged view of detail area 4 of FIG. 3.

FIG. 5 is a partial, enlarged view of detail area 5 of FIG. 3.

FIG. 6 is a side elevation view of a drive rod and cups of the dispensing apparatus with some of the cups removed for ease of illustration.

FIG. 7 is a partial, enlarged view of detail area 7 of FIG. 6.

FIG. 8 is a partial, enlarged view of detail area 8 of FIG. 6.

FIG. 9 is a side elevation view of a drive rod of the dispensing apparatus with engagement members of the drive rod in a disengaged position.

FIG. 10 is a side elevation view of the drive rod of FIG. 9 with the engagement members moving from the disengagement position to the engagement position.

FIG. 11 is a side elevation view of the drive rod of FIG. 9 with the engagement members of the drive rod in the engaged position.

FIG. 12 is a partial, enlarged view of detail area 12 of FIG. 9.

FIG. 13 is a partial, enlarged view of detail area 13 of FIG. 10.

FIG. 14 is a partial, enlarged view of detail area 14 of FIG. 11.

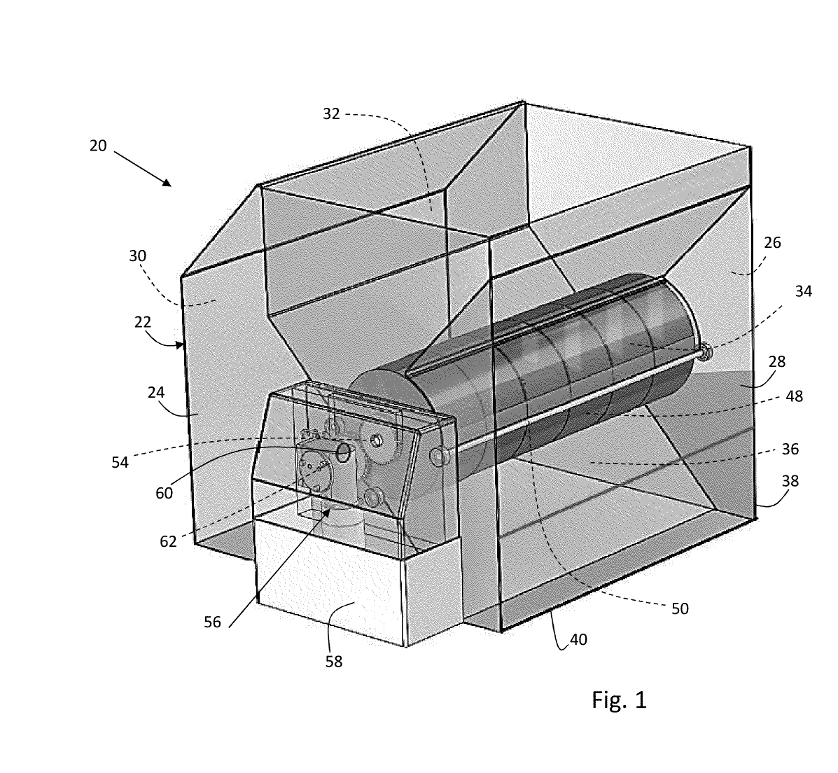

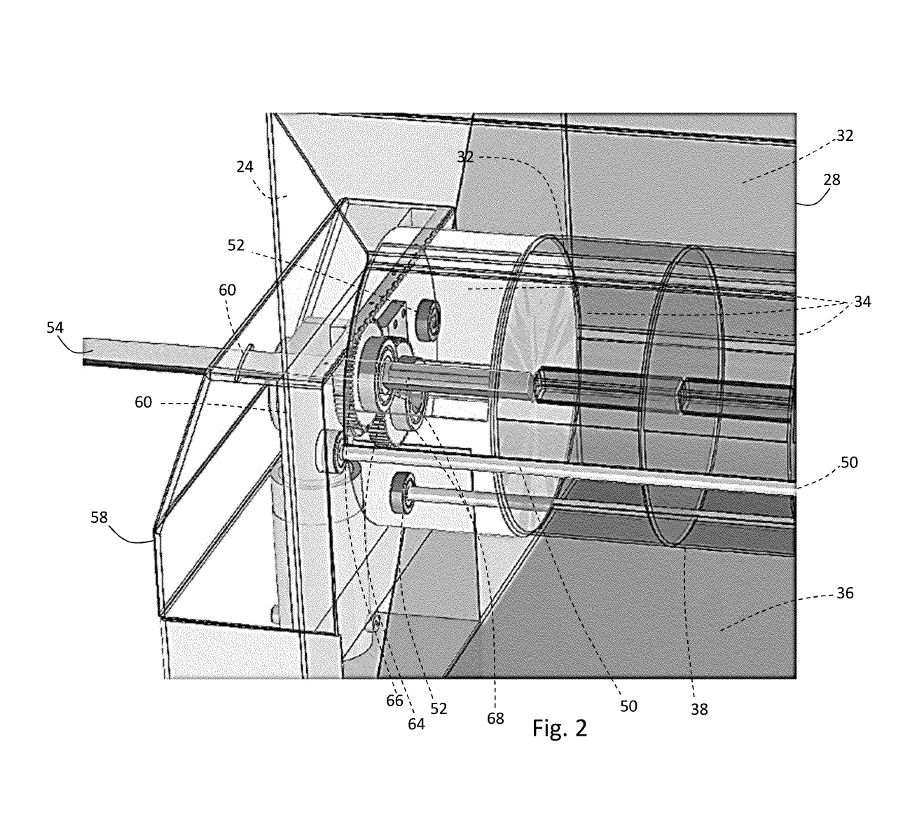

### DETAILED DESCRIPTION

The terms “left,” “right,” “front,” “back,” “above,” “below,” “top,” and “bottom” are used for the sake of convenience in describing features of the dispensing apparatus as those features appear in the drawings, and the terms are not to be considered limiting in any respect.

The dispensing apparatus 20 may having a frame 22 comprising opposing side walls to support and provide mounting locations for various components of the dispensing apparatus hereinafter described. For instance, upstanding, rectilinear left and right side walls 24,26 may extend between upstanding, rectilinear front and back side walls 28,30 to provide the frame with a general box-like form. Other shapes and/or combinations (i.e., number and location) of side walls may also be provided. The frame 22 may support a hopper and storage compartment 32 for storing a substance to be dispensed. The storage compartment may extend between the left and right side walls 24,26. The frame may also support cups 34 located below the storage compartment 32 to allow the cups to receive a substance from the storage compartment through gravity. The substance may a dry, granular substance, such as animal feed. The substance may also be a dry liquid material, such as, shot, sand, powder; or a wet liquid material. The storage compartment 32 may have angled or curved surfaces to direct the dispensed substance toward the cups 34 within the frame. The frame 22 may also support a dispensing duct 36. The dispensing duct 36 may be located below the cups to allow the dispensed substance to be transferred from the cups 34 to the dispensing duct through gravity. The dispensing duct 36 may have angled or curved surfaces which direct the dispensed substance from the cups through the dispensing duct. The dispensing duct 36 may have an access 38 which allows the dispensed substance to spill out, for instance, onto the ground or into a trough (not shown). The frame 20 may include a lid (not shown) that fits over the hopper and storage compartment 32. The frame 20 may also have supports 40 (e.g., a flat base) to allow the dispensing apparatus to be positioned on a flat surface, for instance, the floor or the ground. The frame 20 may also have supports (not shown) to allow the dispensing apparatus to be mounted above the ground on a support mechanism, for instance, a pole, a post, a building wall, etc.

The cups 34 may comprise cylindrical members with a hollow interior 42. The cylindrical members may have an outer peripheral surface 44 which is interrupted with an opening 46 that leads into the hollow interior 42. The cups 34 may be dimensioned such that the volume of the hollow interior 42 corresponds to a serving size. While the cups are shown cylindrical, other shapes may be used.

A cylindrical shroud 48 may be provided in the frame 22 between the left and right side walls 24,26 around the cups 34. The shroud 48 may be disposed between the hopper and the storage compartment 32 and the dispensing duct 36. The cups 34 may be rotatably disposed within the shroud 48. The shroud 48 may be dimensioned to fit around the cups 34 to allow rotation of the cups in the shroud without the dispensed substance becoming entrapped therebetween. By providing a shroud 48, the contents of the cup 34 may be contained within the hollow interior 42 of the cup as the opening 46 of the cup is rotated from alignment with the hopper and storage compartment 32 and the dispensing duct 36.

The frame 22 may include one or more support rods 50 that extend between the left and right side walls 24,26 and adjacent to the cups 34. The support rod 50 may rotate with the cups. The support rod 50 may be joined to the frame 22 with bearings 52 to allow rotation of the support rod when the cups rotate. The support rod 50 may be disposed within the shroud 48. The shroud 38 may also be interrupted in the areas of the support rods (e.g. a slit) to allow the shroud to closely confirm to the outer peripheral surface 44 of the cups 34 and for the support rods to support the cups during rotation.

The dispensing apparatus 20 may be provided with a drive rod 54 that is rotatably disposed within the frame 22. The drive rod 54 may extend through a side of the frame and selectively engage one or more cups. As will be described in greater detail below, the drive rod 54 may selectively engage one or more of the cups to allow each selectively engaged cup to rotate between a dispensed substance receiving position in which the opening of the cup 46 is aligned with the storage compartment 32, and a dispensed substance dispensing position in which the opening of the cups is aligned with the dispensing duct 36 to pass dispensed substance thereto. The drive rod 54 may be removably connected with the dispensing apparatus.

A drive mechanism 56 may rotate the drive rod 54 thereby rotating the cups 34 as will be explained below. The drive mechanism 56 may be contained in a drive compartment 58 on a side wall of the frame, for instance, the left side wall 24 as shown in the Figures. The drive compartment 58 may include an access opening 60 to allow removal of the drive rod. The drive mechanism 56 may include a motor 62, which may be electrical or pneumatic, and associated gears 64,66 to rotate the cups 34 and drive rod 54 with a sufficient amount of torque. The gears 64,66 may rotate in position within the drive compartment 58. For instance, the gears 64,66 may be rotatably mounted to structures in the drive compartment and/or a side wall 24 of the frame using bearings 68. The gears may include a center gear 66, and the drive rod 54 may be driven by the center gear. The drive rod 54 may be removably connected to the center gear 66. The number of gears and the gear reduction ratio may be selected as desired to rotate the drive rod and cups using a desired amount of torque for a given type of motor. The drive mechanism 56 may include electrical connections and a timer (not shown) in order to actuate the drive, drive rod and cups at a preselected times of day.

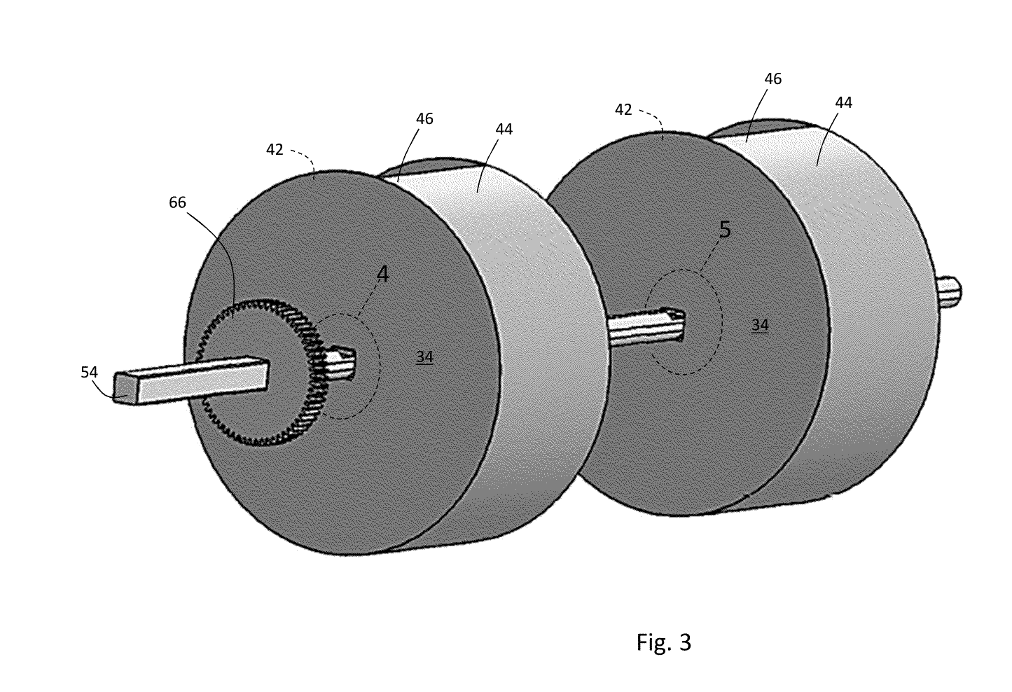

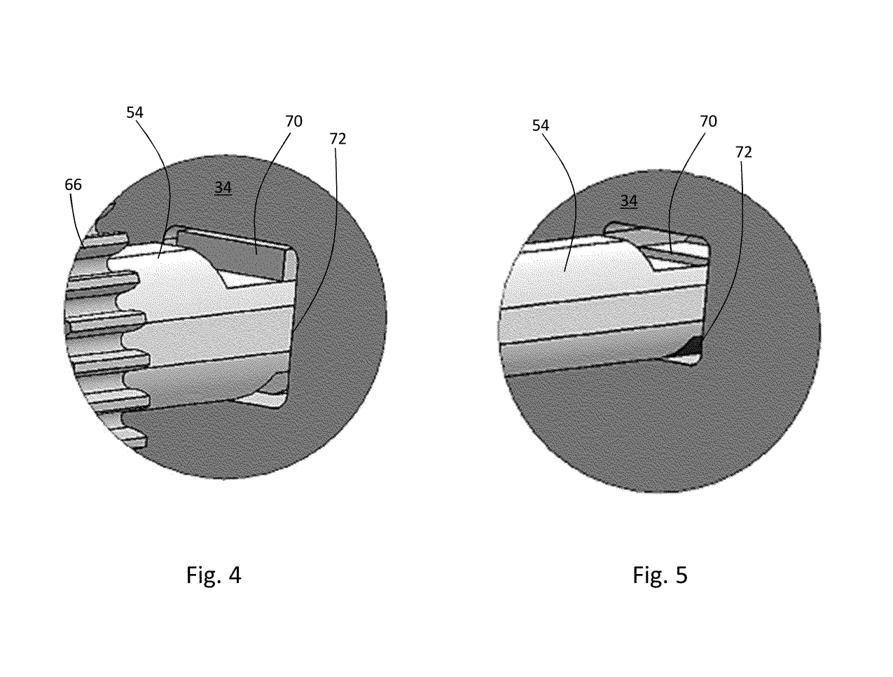

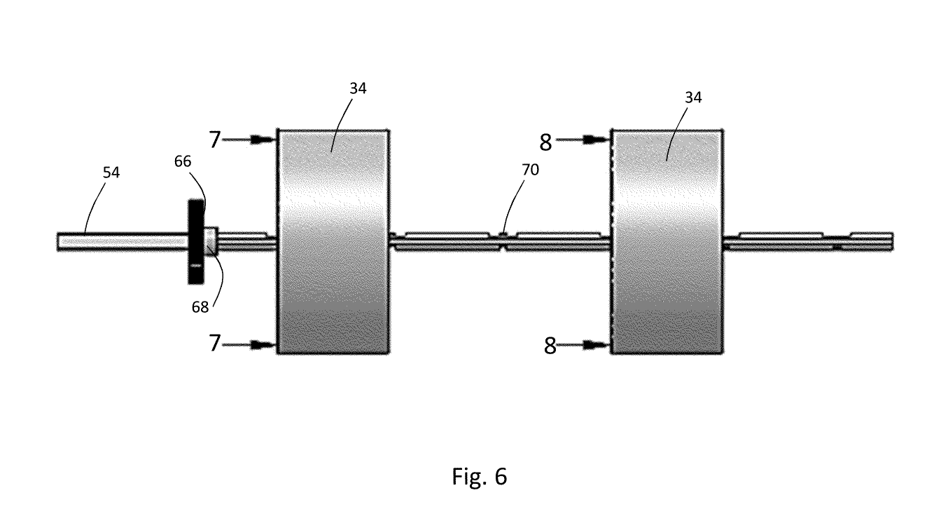

FIGS. 3-14 provide additional detail of the drive rod 54 and its operative connection with the cups 34. The drive rod 54 may have one or more engagement members 70, each of which may be independently movable between an engagement position and a disengagement position. In the engagement position, the engagement member 70 may engage one or more respective cup(s), thereby coupling the drive rod 54 to the selected cup(s) 34 to allow rotation of the cup(s) with the drive rod. In the disengagement position, the engagement member 70 may disengage from one or more respective cup(s) 34, such that the drive rod 54 may be effectively disconnected from the cups, thereby allowing the cups to remain stationary as the drive rod is rotated. For instance, as shown in the drawings, each of the cups 34 is generally cylindrical in shape and has a bore 72 with a geometry configured to engage one respective engagement member 70 of the drive rod 54 when the engagement member is in the engagement position. The cup's bore 72 has a geometry that is configured to be disengaged from the engagement member when the engagement member is in the disengagement position.

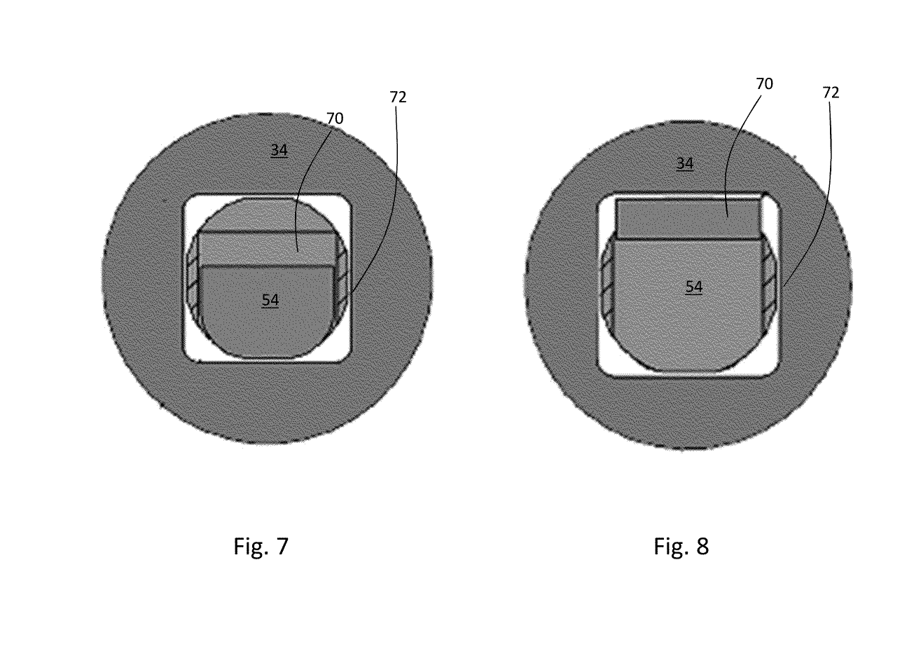

FIGS. 7 and 8 provide detail of an exemplary embodiment of the bore 72 of the cups 34. In FIG. 7, the engagement member 70 is shown in the disengagement position. In FIG. 8, the engagement member 70 is shown in the engagement position. The bore 72 of the cup 34 has a geometry that cooperates with the engagement member 70 such that when the engagement member is in the engagement position, the drive rod 54 is effectively coupled to the cup (FIG. 8) and when the engagement member is in the disengagement position, the drive rod is effectively disengaged from the cup (FIG. 7). While FIGS. 3-8 show the cup 34 with a square shaped bore 72, and the engagement member 70 with a rectangular profile that cooperates with the cup's square shaped bore, other shapes may be used. For instance, a system of interlocking grooves and tabs, a ratcheting system, a spring loaded pin and hole mechanism, and/or a cooperating system of splines may be used.

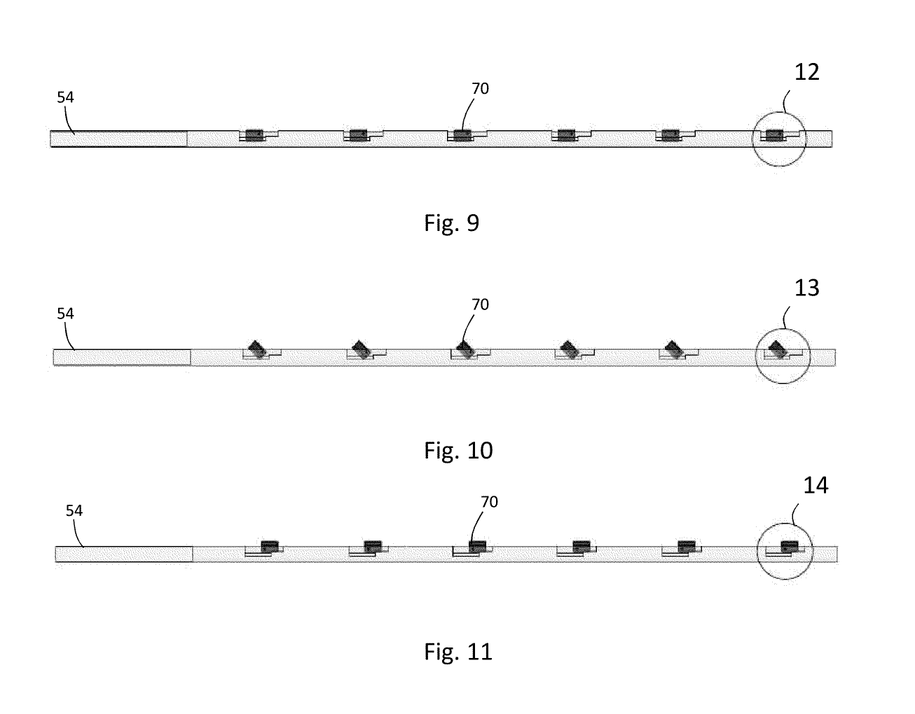

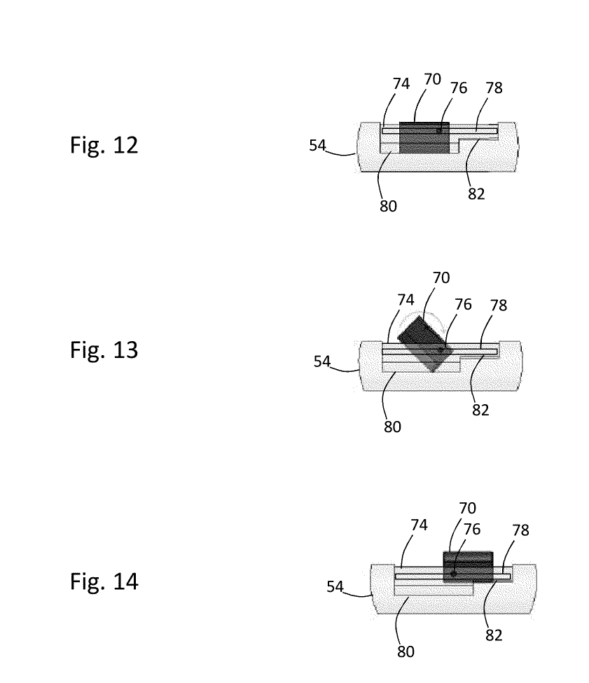

FIGS. 9-14 provide further detail of an exemplary embodiment of the engagement member 70 and drive rod 54. The number of engagement members 70 may correspond to the number of cups 34. Also, one or more cups may be ganged together and coupled to the drive rod with one engagement member. The engagement member 70 may be slidingly contained in a track 74 of the drive rod. A track 74 may be provided on the drive rod for each engagement member. A track may be provided on the drive rod that corresponds with the position of one or more cups. The engagement member 70 may have a pin 76 that fits within in a groove 78 of the track 74 thereby allowing the engagement member to be slidingly connected with the track. The track 74 may have two depths. A first depth 80 of the track may allow the engagement member 70 to slide in a position where the engagement member extends from the drive rod 54 at a first distance that is insufficient to engage the cup 34. A second depth 82 of the track may allow the engagement member 70 to slide in a position where the engagement member extends from the drive rod 54 at a second distance that is sufficient to engage the cup 34. The track 74 may be configured to enable the engagement member 70 to pivot about the pin 76 between the engagement position in which the engagement member extends from the track a distance sufficient to engage the cup and the disengagement position in which the engagement member extends from the track a distance that is insufficient to engage the cup. As best shown in FIGS. 12-14, the engagement member pin 76 slides within the groove 78 of the track 74. The track 74 slidingly accommodates the engagement member 70 in the disengagement position, slidingly accommodates the engagement member in the engagement position, and pivotally accommodates the engagement member as it moves between the engagement and disengagement positions. The pin 76 may offset relative to the height of the engagement member, to allow the engagement member 70 to extend from the track 74 a different amount depending upon the orientation of the engagement member in track.

While the drawings show an engagement member 70 which may slide and pivot in a track 74 between two positions, the engagement member may also comprise a spring loaded button or other mechanism which enables the engagement member to move between the engagement position and the disengagement position. Additionally, while the drawings show the engagement member engaging the bore of the cups, the engagement member may also be configured to engage a side face of the cup.

To operate the dispensing apparatus, the drive rod 54 may be removed from the frame 22 and the engagement members 70 may be positioned in the engagement position or disengagement position corresponding to the desired number of the cups 34 to be used in dispensing dispensed substance and the position of those cups relative to the frame, dispensing duct 36, and access opening 38. The number and position of the cups 34 may be set for portion sizes and position within the access opening of the dispensing duct. For instance, if three animals are desired to be fed, three cups may be selected in the plurality of cups to dispense food. The remaining cups may be idled. The cups to be engaged may have their corresponding engagement members placed in the engagement position and the cups to be idled may have their engagement members placed in the disengagement position. Additionally, the cups to be engaged may be spaced from one another by idled cups to allow each cup to dispense its dispensed substance to a position in the access opening 38 that is spaced from another dispensing position by the width of an idled cup, thereby providing each animal with its own portion spaced from another animal's portion. By aligning the cups horizontally across the dispensing apparatus, each cup 34 corresponds to a different position in the storage compartment 32 and a different position in the dispensing duct 36. This enables the dispensed substance to be distributed more evenly from the dispensing duct 36 and the access opening 38, and to be more evenly emptied from the storage compartment 32, preventing the dispensed substance from accumulating in certain areas of the storage compartment where one cup may be idled. For instance, an idled cup would tend to have an excessive amount of the dispensed substance stored above it in the storage compartment, whereas, an engaged cup would deplete the dispensed substance from the area of the storage compartment directly above it. In a similar manner, by allowing each cup to have a specific location relative to the dispensing duct 36 and access opening 38, multiple animals may be fed as each cup dispenses the dispensed substance within a specific location in the dispensing duct and access opening. Aligning the cups along a length of the drive rod facilitates positioning each cup in a desired location relative to the storage compartment and the dispensing duct.

Once the engagement members 70 are set as desired for the cups 34 to be engaged and/or disengaged, the drive rod may be installed in the dispensing apparatus and with the drive rod engaging the center gear 66. The drive mechanism 56 may then be operated to rotate the drive rod 54 and rotate the cups to dispense the dispensed substance. The drive mechanism 56 may be configured to rotate the drive rod 54 in one direction. The drive mechanism 56 may be also configured to rotate the drive rod 54 in two directions. For instance, in one direction, the drive rod may rotate continuously in the clockwise or counter-clockwise direction between the dispensed substance receiving position and the dispensed substance dispensing position. The drive mechanism may also be configured to oscillate the drive rod between the dispensed substance receiving position and the dispensed substance dispensing position.

In the alternative, the drive rod 54 may be configured without an engagement member that is positionable between an engagement position and a disengagement position. The drive rod may engage a cup directly as the drive rod is inserted into the bore of a cup. In this way, the drive rod 54 may be positioned within the frame so as to engage a selective number of successive cups 34. For instance, when one cup is desired to be engaged, the drive rod 54 may be positioned in the dispensing apparatus such that the drive rod engages the first cup in the line of cups. When two cups are desired to be engaged, the drive rod 54 may be positioned in the dispensing apparatus such that the drive rod engages the first two cup in the line of cups.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A dispensing apparatus comprising:
a frame having a storage compartment configured for storing a substance to be dispensed and a dispensing duct configured for dispensing the dispensed substance; and
a plurality of cups, each cup in the plurality of cups comprising a member with a hollow interior and an opening in the member communicating with the hollow interior, the cups being selectively rotatable within the frame with a drive rod between a dispensed substance receiving position in which the selected cup has its opening aligned in communication with the storage compartment to receive the dispensed substance therefrom and a dispensed substance dispensing position in which the selected cup has its opening aligned in communication with the dispensing duct to pass the dispensed substance thereto.

2. The dispensing apparatus of claim 1 wherein each of the cups comprises a serving size.

3. The dispensing apparatus of claim 1 further comprising a cylindrical shroud between storage compartment and dispensing duct.

4. The dispensing apparatus of claim 1 wherein each of the cups is independently selectively rotatable.

5. The dispensing apparatus of claim 1 wherein each of the cups has an outer periphery which is interrupted to form opening.

6. The dispensing apparatus of claim 1 wherein the cup outer periphery forms seal with the storage compartment when the cup selectively rotates to the dispensed substance dispensing position.

7. The dispensing apparatus of claim 1 wherein the cup outer periphery forms a seal with the dispensing duct when the cup is selectively rotated to the dispensed substance receiving position.

8. The dispensing apparatus of claim 1 wherein each cup passes the dispensed substance to a different location in the dispensing duct when the cup is selectively rotated to the dispensed substance dispensing position.

9. The dispensing apparatus of claim 1 wherein the each cup receives the dispensed substance from a different location in the storage compartment when the cup is selectively rotated to the dispensed substance receiving position.

10. A dispensing apparatus comprising:
a frame having a storage compartment configured for storing a substance to be dispensed and a dispensing duct configured for dispensing the dispensed substance;
a plurality of cups disposed in the frame, each cup in the plurality of cups comprising a member with a hollow interior and an opening in the member communicating with the hollow interior of the cup;
a drive rod having an engagement member configured for selectively, operatively engaging at least one cup, the engagement member being movable between an engagement position in which the engagement member is configured to operatively engage a cup and a disengagement position in which the engagement member is configured to be disengaged from the cup, the drive rod being rotatable within the frame in a manner such that: (i) a cup that is engaged with the drive rod through a respective engagement member being in the engagement position is movable between a dispensed substance receiving position in which the cup opening is aligned in communication with the storage compartment to receive the dispensed substance therefrom and a dispensed substance dispensing position in which the cup opening is aligned in communication with the dispensing duct to pass the dispensed substance thereto, and (ii) a cup that is disengaged from the drive rod through a respective engagement member being in the disengaged position does not move with the cup engaged with the drive rod.

11. The dispensing apparatus of claim 10 wherein the cup is cylindrical.

12. The dispensing apparatus of claim 10 wherein the cups are aligned along a length of the drive rod.

13. The dispensing apparatus of claim 10 wherein the cup has a bore with a geometry configured to be engaged by the engagement member when the engagement member is in the engagement position, and disengaged by the engagement member when the engagement member is in the disengagement position.

14. The dispensing apparatus of claim 10 wherein the engagement member extends radially outward from the drive rod a greater distance when the engagement member is in the engagement position than when the engagement member is in the disengagement position.

15. The dispensing apparatus of claim 10 wherein the drive rod is removable from the frame.

16. The dispensing apparatus of claim 10 wherein the drive rod has an engagement member for each cup.

17. The dispensing apparatus of claim 10 wherein the engagement member of one cup may be positioned in one of the engagement and disengagement position independently of an engagement member of another cup.

18. A dispensing apparatus comprising:
a frame having a storage compartment configured for storing a substance to be dispensed and a dispensing duct configured for dispensing the dispensed substance;
a plurality of cups, each cup in the plurality of cups comprising a member with a hollow interior and an opening in the member communicating with the hollow interior, each of the cups being rotatable within the frame between a dispensed substance receiving position in which the cup opening is aligned in communication with the storage compartment to receive the dispensed substance therefrom and a dispensed substance dispensing position in which the cup opening is aligned in communication with the dispensing duct to pass the dispensed substance thereto; and
a drive rotatable within the frame, the drive rod having an engagement member configured for selectively, operatively engaging at least one cup, the engagement member being movable between an engagement position in which the engagement member is configured to operatively engage a cup and a disengagement position in which the engagement member is configured to be disengaged from the cup;
wherein a cup engaged with the drive rod with the respective engagement member in the engagement position is movable with rotation of the drive rod between a dispensed substance receiving position in which the cup opening is aligned in communication with the storage compartment to receive the dispensed substance therefrom and a dispensed substance dispensing position in which the cup opening is aligned in communication with the dispensing duct to pass the dispensed substance thereto; and
wherein a cup disengaged from the drive rod with the respective engagement member in the disengaged position does not rotate with the drive rod.

19. The dispensing apparatus of claim 18 wherein the cup has a bore with a geometry configured to be engaged by the engagement member when the engagement member is in the engagement position, and disengaged by the engagement member when the engagement member is in the disengagement position.

20. The dispensing apparatus of claim 18 wherein the engagement member extends radially outward from the drive rod a greater distance when the engagement member is in the engagement position than when the engagement member is in the disengagement position.
